(19) United States
(12) Patent Application Publication
(10) Pub. No.: US 2011/0173130 A1
(43) Pub. Date: Jul. 14, 2011

(54) METHOD AND SYSTEM FOR INFORMING A USER BY UTILIZING TIME BASED REVIEWS

(76) Inventors: William Benjamin Schaefer, IV, San Francisco, CA (US); Michael Philip Lasmanis, San Francisco, CA (US); Jason James Kelly, Long Beach, CA (US); John Birchfield, Ben Lomond, CA (US); Leith Leedom Alan, Palo Alto, CA (US); Michael Ayhan, San Francisco, CA (US)

(21) Appl. No.: 12/687,089

(22) Filed: Jan. 13, 2010

(51) Int. Cl. G06Q 99/00; G06Q 30/00; G06F 17/30

(52) U.S. Cl. 705/347; 707/769; 707/802; 707/E17.014; 707/E17.044

(57) ABSTRACT

A method and system for informing a user by utilizing time based reviews that include collecting a plurality of user reviews. A user review includes business information, a user opinion that includes at least a rating, and time information that relates to the time of user interaction with the business. The method further includes extracting information from the plurality of user reviews based on the interaction time and presenting the extracted information to a user.

### TECHNICAL FIELD

This invention relates generally to the online reviewing field, and more specifically to a new and useful method and system in the online reviewing field.

### BACKGROUND

There are numerous companies and websites that deal with organizing user reviews of products, businesses, and experiences. Many of these reviews rely on a form of a rating system. The use of a user providing a satisfaction score, a star rating, or simply a thumbs up or thumbs down are typical techniques for gauging a opinions of users. Additionally, many review systems allow users to write detailed descriptions of their opinions as the main source of review. Much of the context of the numerical rating is explained in these written descriptions. However, a user must read numerous textual reviews to interpret the meaning of a rating. Not only does this burden the user with reading and interpreting the reviews, but it also limits the amount of information used by a user for making a decision. A user often does not have the time or the desire to read and assimilate the information in hundreds of reviews. Additionally, many reviews lose their relevancy over time since many business fluctuate greatly over their lifetime. Thus, there is a need in the online review field to create a new and useful method and system for informing a user by utilizing time based reviews. This invention provides such a new and useful method and system.

### BRIEF DESCRIPTION OF THE FIGURES

FIG. 1 is flowchart representation of a method of a preferred embodiment of the invention;

FIG. 2 is a schematic representation of a system of a preferred embodiment of the invention;

FIG. 3 is an exemplary graphic of map variation of a visual media representation of the plurality of user reviews;

FIGS. 4A-4C are exemplary time chart variations of a visual media representation applied to different constraints;

FIGS. 5A and 5B are exemplary screenshots of organized results of query request; and

FIG. 6 is a representation of identifying an optimal business suggestion near a user.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

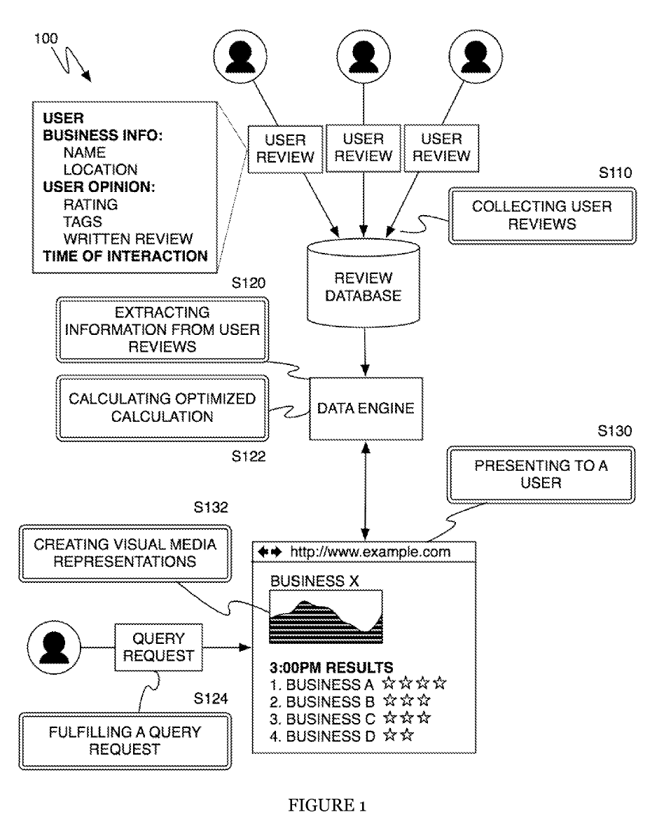

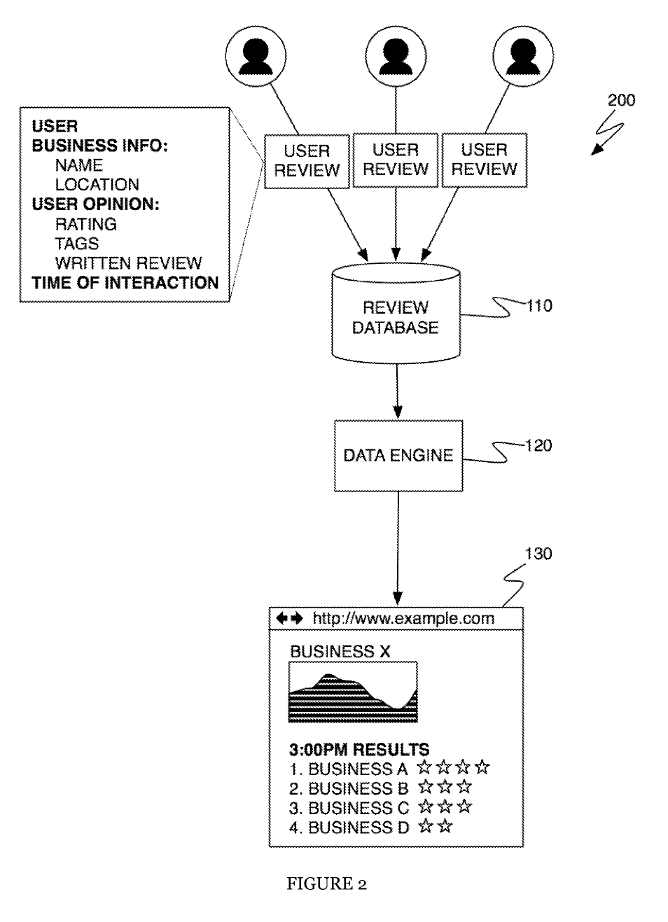

As shown in FIG. 1, a method 100 of the preferred embodiment includes collecting a plurality of user reviews that include time of user interaction with a business S110, extracting information from the user reviews based on the interaction time S120, and presenting the extracted information to a user S130. The method of the preferred embodiment functions to take advantage of reviews with a high correlation to the time a user experienced an interaction with a business. The information extracted from a plurality of users over an extended period of time has many variations and applications for a user trying to find information about businesses. The method has particular application to restaurant review websites, crowd source review tools, and any other suitable application of user reviews.

Step S110, which includes collecting a plurality of user reviews that includes time of user interaction with a business, functions to collect a dataset of business ratings correlating to a time the user was interacted with the business. The user reviews are preferably collected for a plurality of businesses by a plurality of different users. The reviews may alternatively be for only a single user however. The user reviews are preferably collected over a diverse set of times such as over the course of a day, a week, a year, or any suitable span of time. The user reviews are preferably collected from online submissions provided by a user. The user reviews are preferably submitted from a mobile device at the site of the entity being reviewed, but the user reviews may alternatively be submitted through a website from a laptop or a personal computer, or any suitable device to submit an online electronic review. The user reviews preferably include business information, a user opinion, and time of user interaction with a business (interaction time). The business information preferably includes a business name and preferably additionally includes the business location or any suitable identifiable information. A business is preferably any place that provides a service or product, but may additionally include any entity that may be user reviewed such as an event (e.g., such as a concert) or a location (e.g., a public park). A user opinion preferably includes at least a rating. The rating is preferably a quantifiable and relatable metric for evaluating the user opinion of the business. The rating is preferably a linear scale 1 through 10 that indicates positive to negative opinion of the user. The rating may alternatively be a star rating, a thumbs up/down rating, a relatable text selection (e.g., selecting from ‘bad’, ‘neutral’, and ‘good’), or any suitable device for providing a rating. Multiple ratings for different aspects may additionally be collected. For example, for restaurant reviews, a user may rate food, service, and atmosphere independently. The user opinion may additionally include textual tags. A tag is preferably any suitable keyword or text that can be associated with or assigned to a piece of information. Tags may be used as part of the rating. The tags may have a mapping to some quantifiable value such as a tag for ‘delicious’ would map to a high rating for food and ‘slow’ may map to a low rating for service. Tags may additionally be used for relating user reviews that share common tags. The tags may alternatively or additionally be used for indicating the product involved in the user interaction with the business. For example, the tag may describe the dish ordered by a client at a restaurant or a tag may describe an item the user purchased at a store. The user opinion may additionally include a written description, such as a written review. Any suitable natural language processing may be used to extract information from the written review such as to form a rating or to form tags. The interaction time or the approximate time a user experiences or interacts with a business is additionally part of the user review. The interaction time may alternatively be the time the user typically visits a business for the case where the user frequents the business on a regular basis. The interaction time is preferably collected at substantially the same time as the user-business interaction. For example, a user preferably submits a user review from a phone or some other electronic device while at the business (e.g., a restaurant). The interaction time may alternatively be manually entered by the user such as if the user review is submitted at time after the interaction. In one variation, a mobile device of the user preferably obtains the location of the user (through GPS, signal triangulation, or any suitable method). The user location is then compared to location information of the business identified in the business information. If the user is determined to be substantially near the business then the time the review is submitted may be used. If the user is determined to not be located at the business then the user will be asked to input what time the interaction occurred. The interaction time is preferably the local time as opposed to a standard global time. This functions so that when a user submits a user review at noon Dec. 8, and then another review in a different time zone is also submitted at noon Dec. 8 then those two user reviews would be interpreted as happening at the same time of day even though they may have occurred at hours apart. Alternatively the time may be interpreted in any suitable manner.

Step S120, which includes extracting information from the user reviews based on the interaction time, functions to create information that is easily interpretable and relevant to a user from a large collection of user reviews. The interaction time of the plurality of user reviews is preferably used to identify patterns and trends in the data. The interaction time and the user opinion (e.g., the rating) of user reviews are preferably analyzed based on constraints defined around businesses, geographic locations, particular users, or any suitable context to set the user review data. The number of ratings for a business, the frequency of the ratings, maximum rating, minimum rating, average rating, and any other trait of the user reviews may be used as a basis for extracting and organizing information. There are numerous variations including calculating an optimized suggestion S122 and fulfilling a query request of the user reviews S124.

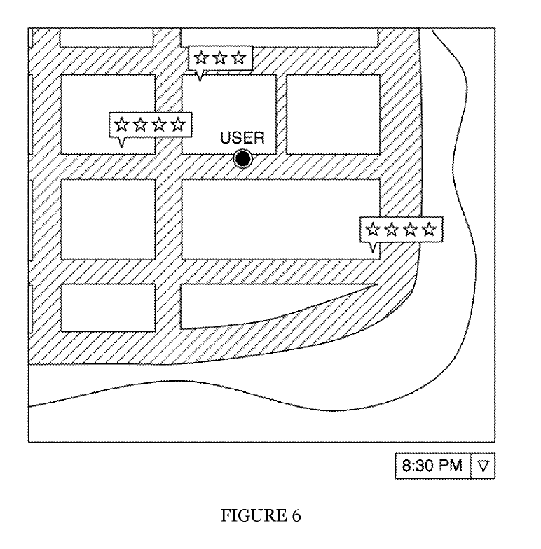

Step S122, which includes calculating an optimized suggestion, functions to optimize particular portions of a user review based on particular restrictions set by the application. Optimizing data more specifically functions to calculate suggestions for a user based on the user reviews. As detailed below these suggestions may also be constrained by a query request. In a first variation, the optimization of data includes identifying one user similar to a first user based on the respective ratings of businesses and the interaction time of those ratings and identifying at least one business suggestion from the similar user to present to the first user in Step S130. This variation functions to identify similar patterns in habits and time trends in how users select a business. A plurality of similar users may additionally be identified. As a second variation, the optimization includes identifying a trend of peak ratings for a business, which functions to generate suggestions for the optimal time to visit (or conversely not visit) a business. A ratings trend may be based on a pattern for a time frame defined by a day, a week, month, season, year, full lifespan of a business, or any defined time period. In the variation where the user review includes information about the product purchased (or used) then the trend may be identified for a particular product. So for example, a particular dish in a restaurant may be suggested for lunch because many user reviews made near noon indicate that the user had positive experience and that they ordered this dish. As another example, a particular time of year may be suggested for visiting a business that is more seasonal in product offerings. As another variation, optimization of data includes calculating a highly rated restaurant near a user, as shown in FIG. 6. The calculation preferably includes receiving location information from a user device (e.g., a smart phone) and identifying a business that at that period of time would predict a maximum rating with a minimal distance from the first user. Any number of near by suggestions may be made. As yet another variation, the optimization may be a recommendation for the temporal order of events. This temporal order recommendation preferably suggests other businesses that were commonly enjoyed by users after visiting a first business. The first business is preferably the current location of the user. As an example a first user at a restaurant will receive a recommendation for a dessert place that is often enjoyed by users that had eaten at the restaurant beforehand. The plurality of users used in an optimization calculation may additionally be segregated by specific user groups. For example, a user may specify an optimization should be made based on reviews made by contacts (or friends within a social network), a specific demographic, a group of known experts or any suitable user group.

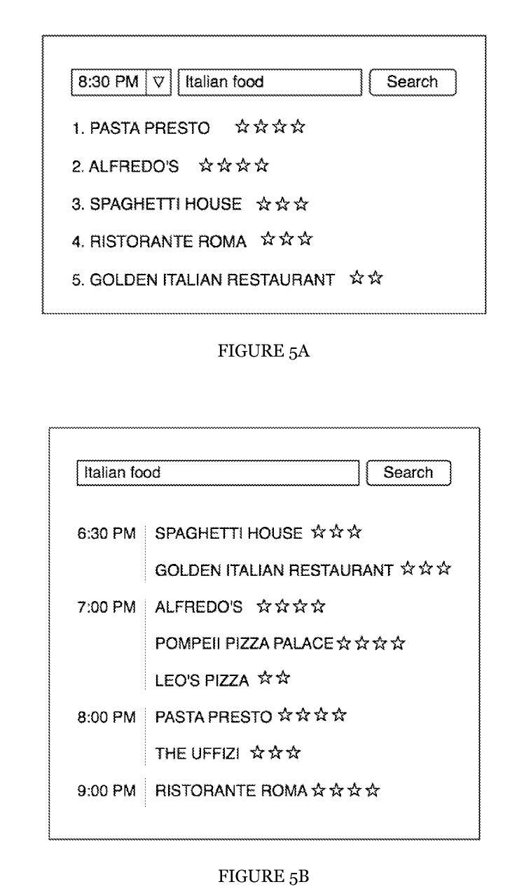

Step S124, fulfilling a query request of the user reviews functions to complete a search of the user reviews. Step S124 preferably includes receiving a query request, isolating businesses identified by the search query, and organizing the results by rating and/or interaction time. Step S124 may be implemented in a number of ways. The time period may be defined for the search, either received from the user or determined by the time the search is conducted. In this variation, a search result will return businesses that match the search query and that have the top rating within the defined time period, as shown in FIG. 5A. Additionally, location information may be used so that the search results may be temporally ordered to recommend results that have the highest rating around that time and near that location. In a second variation, the results are organized in chronological order according to the optimal time to visit each business. Each business that matches the search query preferably has at least one but alternatively multiple optimal times. The businesses matching the query request are preferably ordered in chronological order according to the optimal time for the respective business, as shown in FIG. 5B.

Step S130, which includes presenting the extracted information to a user, functions to convert the extracted information into human interpretable information. Preferably the information is presented as textual information on a screen. The information is preferably presented through a webpage, but may alternatively be presented through an application, a text message, an email, audio communicated over the phone, or any suitable format. The extracted information may be formatted as a list when a number of business suggestions have been extracted, similar to a format used by a search engine. Additionally or alternative, presenting the extracted information may include creating a graphic based on the interaction time of user reviews S132.

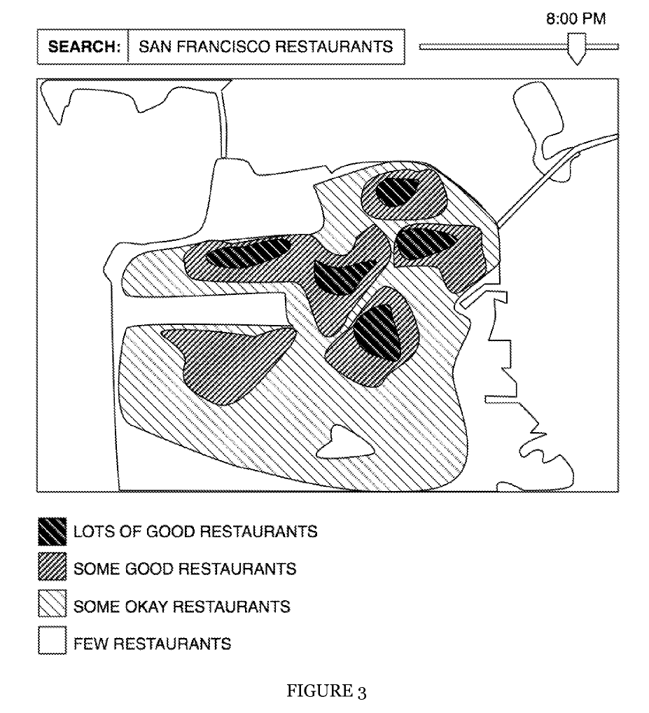

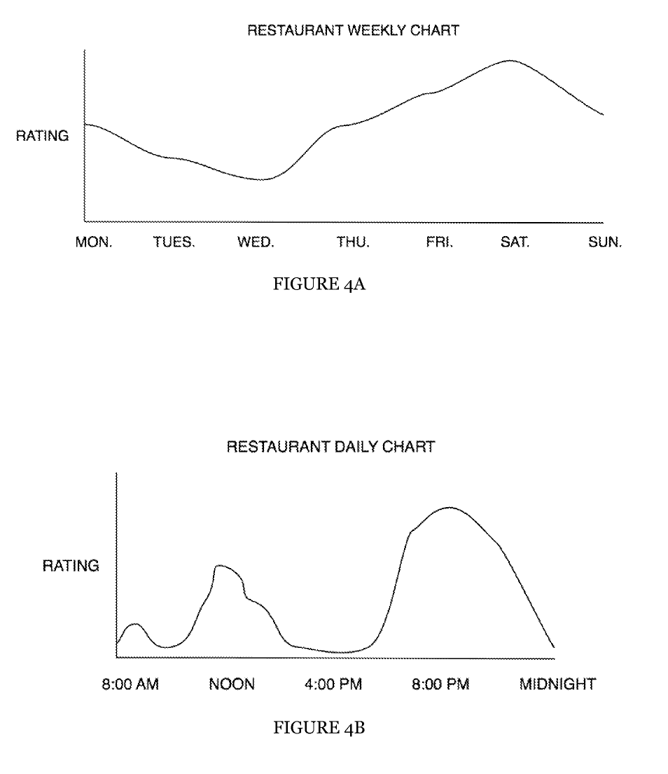

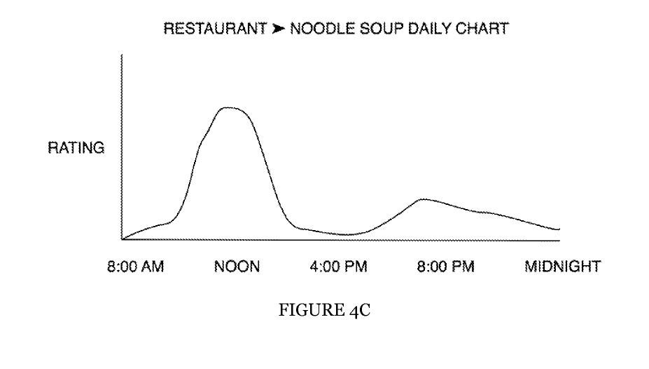

Step S132, which includes creating visual media representation based on the interaction time of the user reviews, functions to convert extracted information into visual representations. The graphic is preferably an infographic using either images or a graph to represent business information in the context of interaction time. As a first variation, Step S132 includes generating a map of ratings for a particular time. The map preferably shows a rating indicator at the location of various businesses as shown. The ratings preferably reflect an average rating for a business during a range of interaction times. The map may additionally be a transformed into a video showing a time-lapse depiction of the map and how the ratings shift and change with time. The map may alternatively be interactive allowing a user to select a time to view, as shown in FIG. 3. This sort of graphic will preferably allow users to identify “hotspots” and when and where they occur in parts of a city. As a second variation, Step S132 includes charting business ratings over time. Since the ratings are related to interaction time, a chart (e.g., a graph or table) can provide unique visual information about the trends of peoples experiences with a business over time. The time chart for a business preferably reflects when a person should and should not visit a business. The time chart is preferably specific for a particular business and shows a graph of average ratings of particular times over a time period. The chart may additionally reflect the volume of ratings for a particular time. The time chart may depict any suitable time period such as a day, week, month, a season, a year, whole life of a business, or any suitable period. The resolution of each time chart is preferably adjusted to best match the purposes of a particular time chart. Showing a daily time chart would reflect the average trends in ratings for a particular day, as shown in FIG. 4B, preferably with at least hourly resolution. A weekly time chart would reflect the average trends in ratings for each day of the week (e.g., at least daily resolution), as shown in FIG. 4A. The time chart may additionally be created for any suitable data element of the user reviews such as a product as shown in FIG. 4C, a genre of businesses, a geographical region, or any suitable label extracted from the user reviews.

A system 200 for informing a user by utilizing time based reviews includes a review database 110 to store time based reviews, a data engine 120 that manages and processes the user reviews to extract information from the reviews stored in the database, and an interface 130 that presents the extracted information to a user. The system functions to substantially implement the method described above. The system 200 may alternatively be implemented by any suitable device, such as a computer-readable medium that stores computer readable instructions. The instructions are preferably executed by a computer readable components for executing the above method of informing a user. The computer-readable medium may be stored on any suitable computer readable media such as RAMs, ROMs, flash memory, EEPROMs, optical devices (e.g., CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

I claim:

1. A method for informing a user by utilizing time based reviews comprising:
collecting a plurality of user reviews, a review including business information, user opinion, and time information, wherein the user opinion includes a rating, wherein the time information relates to the time of user interaction with the business;
extracting information from the plurality of user reviews based on interaction time; and
presenting the extracted information to a user.

2. The method of claim 1, wherein the business information includes business identity and business location.

3. The method of claim 2, wherein the rating is a relatable metric.

4. The method of claim 3, includes calculating at least one optimized suggestion using elements of user reviews as constraints.

5. The method of claim 4, wherein calculating at least one optimized suggestion further includes collecting location information of a user and identifying a business suggestion by maximizing user opinions while minimizing distance from the user to a business location.

6. The method of claim 4, wherein calculating at least one optimized suggestion further includes identifying a second user that is similar to a first user based on respective ratings of businesses and the time of the ratings and selecting a business from the user reviews of the second user to suggest to the first user.

7. The method of claim 4, wherein calculating at least one optimized suggestion further includes identifying an optimal time suggestion of when to interact with a business.

8. The method of claim 4, wherein the user opinion of a review further includes descriptive tags, and extracting information includes relating user reviews that share common tags.

9. The method of claim 8, further including extracting tags from a user written description included in the user opinion.

10. The method of claim 4, wherein the user opinion of a review further includes tags that describe products of a business.

11. The method of claim 10, wherein calculating at least one optimized suggestion further includes identifying at least one optimal product suggestion for a particular time.

12. The method of claim 10, wherein calculating at least one optimized suggestion further includes identifying a time suggestion for a particular product.

13. The method of claim 10, further comprising: receiving a query request; isolating business identified by the query request and calculating a plurality of optimized suggestions from the isolated businesses.

14. The method of claim 13, wherein calculating a plurality of optimized suggestions includes calculating a rating of a business within a defined time period and presenting the businesses in order of rating within the defined time period.

15. The method of claim 13, wherein organizing the optimized suggestion includes organizing the isolated businesses in substantially chronological order of optimal time to interact with the business.

16. The method of claim 4, further comprising creating visual media representations of the extracted information to present to the user.

17. The method of claim 16, wherein the visual media representation is map of user ratings for a defined period time period.

18. The method of claim 16, wherein the visual media representation is a chart with time as a variable of the chart.

19. A system for informing a user by utilizing time based reviews comprising:
a review database that stores a plurality of user reviews collected from a plurality of users;
wherein a user reviews includes:
business information;
user rating; and
time of the user interaction with the associated business;
a data engine that processes the user reviews; and
an interface that communicates processed results of the data engine to a user.
